(19) United States
(12) Patent Application Publication
(10) Pub. No.: US 2026/0284877 A1
(43) Pub. Date: Sep. 24, 2026

(54) METHOD FOR PLANNING LONG-TERM TASK OF ROBOT AND APPARATUS FOR PERFORMING SAME

(71) Applicant: CHUNG ANG UNIVERSITY INDUSTRY ACADEMIC COOPERATION FOUNDATION, Seoul (KR)

(72) Inventors: EUN WOO KIM, Seoul (KR); JUNG KYOO SHIN, Seoul (KR)

(21) Appl. No.: 19/466,898

(22) Filed: Feb. 2, 2026

(30) Foreign Application Priority Data
Mar. 18, 2025 (KR) 10-2025-0034956

(51) Int. Cl. B25J 9/16

(52) U.S. Cl. CPC B25J 9/1661; B25J 9/161; B25J 9/163

(57) ABSTRACT

A method for planning a long-term task of a robot includes acquiring input information represented in a natural language and object-oriented information, calculating, by a neural network model, a time-series task plan of a robot based on the input information, and acquiring target information for achieving the time-series task plan and retraining the neural network model when the information for calculating a long-term task plan is determined not to be sufficient.

### CROSS-REFERENCE TO RELATED APPLICATION AND CLAIM OF PRIORITY

This application claims the benefit under 35 U.S.C § 119 of Korean Patent Application No. 10-2025-0034956, filed on Mar. 18, 2025, in the Korean Intellectual Property Office, the entire disclosure of which is incorporated herein by reference for all purposes.

### BACKGROUND

### 1. Technical Field

The following description relates to a technology for planning a task such that a robot may perform a given goal.

### 2. Description of Related Art

An existing technology has adopted a method for converting an environment into an object-oriented structure to understand the same, and predicting an optimal operation based on the same.

An existing object-oriented structure-based technology classifies the environment according to pre-defined information, and it is thereby difficult to effectively respond to a complicated environmental change or an unpredicted status. However, in a real world, a new untrained status may occur at any time. When a task plan does not flexibly respond to such a status, there is a risk that the entire plan is halted.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a model for planning a long-term task of a robot by utilizing a large language model so as to be able to flexibly respond to an untrained status.

The disclosed embodiments are also intended to provide an algorithm capable of additionally training a neural network model on untrained information by automatically collecting information from the Internet and processing the same without an intervention of a human.

In one general aspect, there is provided an operation method including: acquiring input information represented in a natural language and object-oriented information; calculating, by a neural network model, a time-series task plan of a robot based on the input information; and acquiring target information for achieving the time-series task plan and retraining the neural network model when the information for calculating a long-term task plan is determined not to be sufficient.

The calculating of the time-series task plan may include: refining the input information to acquire an input feature vector; inputting the input feature vector to an encoder to acquire an environmental feature vector including object information and a command for an environment; inputting the environmental feature vector to a decoder to acquire an operation feature vector including information about an operation to be performed at a specific time; and outputting one or more operation sequences corresponding to the time-series task plan based on the operation feature vector.

The refining of the input information may include converting object information and goal information included in the input information into a language model to acquire an object feature vector and a goal feature vector.

The encoder may be a neural network encoder in which one or more multi-head attention layers are stacked, and the calculating of the time-series task plan may include: merging the object feature vector and the goal feature vector through the encoder to acquire an integrated feature vector; and inputting the integrated feature vector to the encoder to acquire, through the encoder, the environmental feature vector reflecting a comprehensive feature of the environment.

The decoder may include at least one multi-head attention layer and a gated recurrent unit neural network.

The operation method may further include acquiring the environmental feature vector of a current time and task information of a previous time stored in an external memory to acquire a current operation feature vector as an output of the multi-head attention layer, wherein the task information of the previous time includes a context feature vector of the previous time and an environmental feature vector of the previous time.

The gated recurrent unit neural network may combine a current operation feature vector, which is an output of the multi-head attention layer, and a current environmental feature vector, which is an output of the encoder, to acquire a memory feature vector and update an external memory.

The acquiring of the output from the operation feature vector may include: inputting the feature vector to at least one independent neural network; and outputting an action, an object, and a relation from the independent neural network.

The acquiring of the target information may include: acquiring a goal feature vector of a current time from the neural network model; acquiring a goal feature vector of a previous time stored in an external memory; comparing the goal feature vector of the previous time and the goal feature vector of the current time to determine feasibility of performing current goal information; acquiring and refining information related to the goal information of the current time based on the determining of the feasibility; and including the refined information to retrain the neural network model.

The determining of the feasibility may include calculating a cosine distance between the goal feature vector of the previous time and a feature vector of the new goal.

The operation method may include acquiring and refining information related to the goal information of the current time to retrain the neural network model when a result value of the calculating of the cosine distance is not greater than a certain value.

The acquiring of the information may include web-crawling related information using the goal information of the current time as a keyword.

The refining of the information may include: extracting linguistic properties of the crawled information to measure a distance with the goal information of the current time, and; utilizing a language model to organize information with a minimum number of operations and remove irrelevant information, and identifying continuity of the operations to remove information without the continuity; and using the language model to verify whether each operation is convertible to a structure that is understandable and performable by the robot.

In still another general aspect, there is provided a computing device comprising: a processor; and a memory storing one or more programs executable by the processor, wherein the processor is configured to perform: acquiring input information represented in a natural language and object-oriented information; calculating, by a neural network model, a time-series task plan of a robot based on the input information; and acquiring target information for achieving the time-series task plan and retraining the neural network model when information for calculating a long-term task plan is determined not to be sufficient.

The processor may perform: refining the input information to acquire an input feature vector; inputting the input feature vector to an encoder to acquire an environmental feature vector including object information and a command for an environment; inputting the environmental feature vector to a decoder to acquire an operation feature vector including information about an operation to be performed at a specific time; and outputting at least one operation sequence corresponding to a time-series task plan based on the operation feature vector.

The processor may perform: acquiring a goal feature vector of a current time from the neural network model; acquiring a goal feature vector of a previous time stored in an external memory; comparing the goal feature vector of the previous time and the goal feature vector of the current time to determine feasibility of performing current goal information; acquiring and refining information related to the goal information of the current time based on the determining of the feasibility; and including the refined information to retrain the neural network model.

In still another general aspect, there is provided a computer program stored in a non-transitory computer readable storage medium, the computer program including one or more instructions, wherein, when executed by a computing apparatus including one or more processors, the instructions cause the computing apparatus to perform: acquiring input information represented in a natural language and object-oriented information; calculating, by a neural network model, a time-series task plan of a robot based on the input information; and acquiring target information for achieving the time-series task plan and retraining the neural network model when information for calculating a long-term task plan is determined not to be sufficient.

Other features and aspects will be apparent from the following detailed description, the drawings, and the claims.

### BRIEF DESCRIPTION OF THE DRAWINGS

Illustrative embodiments will be described in more in detail with reference to the following figures that are simply a portion of the example embodiments and those skilled in the art to which the present disclosure pertains may readily acquire other figures based on the figures without an inventive work being made.

FIG. 1 is a flowchart of a method for planning a long-term task of a robot according to an embodiment of the present disclosure;

FIG. 2 is a flowchart of an operation method for a neural network model according to the present disclosure;

FIG. 3 illustrates a task planning framework for a task planning neural network according to an embodiment of the present disclosure;

FIG. 4 is a flowchart of a method for acquiring and refining target information and retraining a neural network model according to an embodiment of the present disclosure when information required for calculating a long-term task plan of a robot is not sufficient;

FIG. 5 is a drawing pertaining to an operation for acquiring and refining target information and retraining a neural network model according to an embodiment of the present disclosure when information required for calculating a long-term task plan of a robot is not sufficient;

FIG. 6 is a drawing pertaining to refining collected information according to an embodiment of the present disclosure;

FIG. 7 illustrates that a computing apparatus of the present disclosure executes a task planned for a robot to achieve a goal for making brownie; and

FIG. 8 is a block diagram showing a configuration of a computing apparatus according to an embodiment of the present disclosure.

### DETAILED DESCRIPTION

The following detailed description is provided to aid in a comprehensive understanding of a method, an apparatus and/or a system described in the present specification. However, the detailed description is only for illustrative purpose and the present disclosure is not limited thereto.

In describing the embodiments of the present disclosure, when it is determined that a detailed description of known technology related to the present disclosure may unnecessarily obscure the gist of the present disclosure, the detailed description thereof will be omitted. In addition, terms to be described later are terms defined in consideration of functions in the present disclosure, which may vary according to intention or custom of users or operators. Therefore, the definition of these terms should be made based on the contents throughout this specification. The terms used in the detailed description are only for describing embodiments of the present disclosure and should not be limiting. Unless explicitly used otherwise, expressions in the singular form includes the meaning of the plural form. In this description, expressions such as “including” or “comprising” are intended to indicate any property, number, step, element, and some or combinations thereof, and such expressions should not be interpreted to exclude the presence or possibility of one or more other properties, numbers, steps, elements other than those described, and some or combinations thereof.

Further, terms such as first and second may be used to describe various components, but the components should not be limited by the terms. The terms may be used for the purpose of distinguishing one component from other components. For example, a first component may be referred to as a second component without departing from the scope of the present disclosure, and similarly, the second component may also be referred to as the first component.

Hereinafter, it will be described about an embodiment of the present disclosure in conjunction with the accompanying drawings.

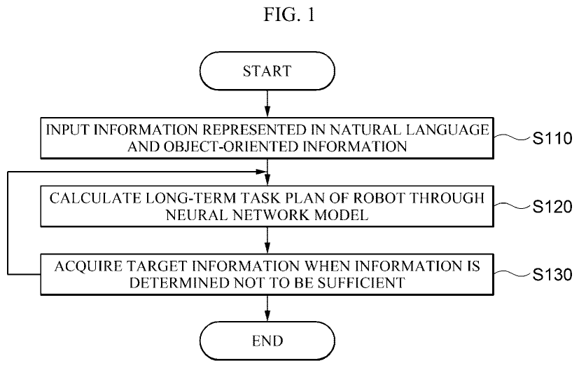

FIG. 1 is a flowchart of a method for planning a long-term task of a robot according to an embodiment of the present disclosure. Such a method may be executed by a computing apparatus.

In step S110, the computing apparatus may acquire information represented in a natural language and object-oriented information, and enable task planning of a robot based thereon. Input information may be formed of information about objects present in an environment and a linguistic description for a goal specified by a user. Accordingly, an input

$${W}_{ing} = [ {w}_{ing}^{1} , {w}_{ing}^{1} , … , {w}_{ing}^{n} ]$$

about the objects present in the may be formed of the information environment and the linguistic description for the goal specified by the user.

The information about the objects present in the environment may include a relation between a list of objects to be recognized by the robot in the environment and attributes of the objects. For example, when the robot is required to do cooking in a kitchen environment, objects such as a refrigerator, a countertop, a kitchen knife, vegetables, and the like may be included, and each object may have the attributes such as a position, a size, usage, or the like. Such object information is represented as structured data, and then a neural network model analyzes the same to use an analyzed result for planning a suitable operation.

The linguistic description for the goal designated by the user may be input as a task goal intended by the user in a natural language. For example, a sentence like “make a sandwich” may be input, and the neural network may analyze the sentence to generate detailed task steps.

In step S120, the computing apparatus may calculate a long-term task plan of the robot based on the input information. The neural network model is an artificial intelligence (AI) model for learning data and recognizing a pattern, is formed of neurons of a multi-layer structure, and operates in a manner for predicting an optimal output based on given input data. A task to be performed by the robot for achieving a specific goal is not a simple short-term plan, but requires a time-series long-term plan that has to go through several steps. For example, when a goal “make sandwich” is given, the neural network model does not simply recognize materials, but requires to predict various steps for cutting bread, washing vegetables, combining sandwich fillings, and the like in time series.

To this end, in the present disclosure, a neural network with an encoder-decoder structure may be used for calculating an optimal task plan based on input information. The encoder integrates input object information and goal information, and extracts an environmental feature vector through a multi-head attention (MHA) layer. Namely, a process for analyzing association of the input information and determining importance to convert into internal representation of the neural network is performed. A decoder generates a suitable operation at each time based on the environmental feature vector acquired from the encoder. To this end, the MHA layer and a gated recurrent unit (GRU) neural network are combined, and through the combination, an optimal task sequence may be calculated considering a previous operation and a current environment.

In step S130, when determining that information required for calculating the long-term plan of the robot is not sufficient, the computing apparatus acquires target information for achieving a time-series task plan and retrains the neural network model. An algorithm may also be executed for automatically compensating for the insufficient information using a large language model (LLM) in the process for planning the long-term task of the robot. For example, when the goal “make sandwich” is given, there may be a case in which the robot does not know how to prepare specific materials (e.g., “tomatoes” or “lettuces”). In this case, the LLM may search the Internet or an embedded database for related information, and automatically obtain the target information like “wash tomatoes and then cut into suitable size”.

Such a process for compensating for the insufficient information is performed in a manner in which the LLM is utilized first to search for insufficient information and add necessary data. It is determined, in comparison to existing training data of the neural network, whether reflecting new information is necessary, and then the new information is combined with the existing data to update the neural network model. According to the addition of the new data, prediction accuracy of the model may be improved, and thereby the neural network model may plan a more precise task.

After the insufficient information is acquired, the computing apparatus may reflect the information to retrain the neural network, and when the information is sufficient, the computing apparatus may plan a long-term task of the robot to output an operation sequence.

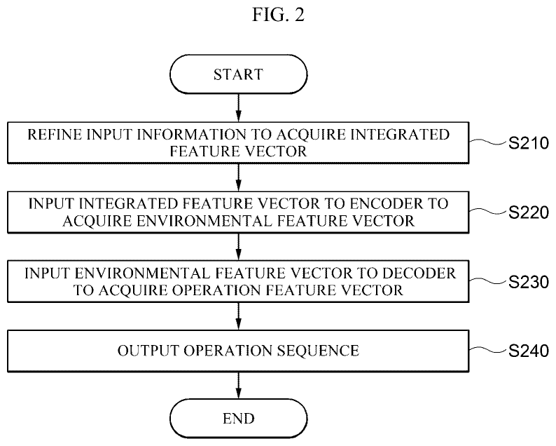

Hereinafter, a detailed description will be given in FIGS. 2 to 4.

FIG. 2 is a flowchart of an operation method for a neural network model according to the present disclosure.

In step S210, the computing apparatus may refine input information to acquire an integrated feature vector. The refining of the input information may be performed by converting object information and goal information included in the input information into a language model to acquire an object feature vector and a goal feature vector.

The object feature vector is a vector representation including linguistic and semantic information about objects that are present in the environment, and the goal feature vector may be a vector representation reflecting a linguistic representation of the goal set by the user,

The operation for converting the object information and the goal information into the language model to acquire the object feature vector and the goal feature vector is a process for converting input natural language data into a vector form that the neural network may process. This may be a process for converting the goal and object information represented in a natural language into the vectors that the neural network may understand.

First, the input information is formed of the object information (e.g., a tool, a material, or the like) present in the environment and the goal information (e.g., “make sandwich”). Such information is represented in a natural language, and thus an LLM may be utilized for vectorizing the information.

The LLM converts the input natural language data into an embedding vector while conserving a semantic relation. In this process, the goal information and the object information each may be represented as feature vectors, and the process may be the same as the following Equation 1.

$${r}_{tgt} = {f}_{LLM} ( {W}_{tgt} ) \qquad ( 1 )$$

$${r}_{ing} = {f}_{LLM} ( {W}_{ing} )$$

In Equation 1, r_{tgt} means the properties for the given goal, and r_{ing} means the properties for the object. f_{LLM} means the LLM.

The feature vector converted in this way is used as an input to the neural network that plans the long-term task of the robot. For example, when the goal information “make sandwich” and the object information [“bread”, “cheese”, and “bacon”] are input, the neural network calculates an optimal task sequence by utilizing the pieces of information.

Thereafter, the object feature vector and the goal feature vector are merged to acquire an integrated feature vector.

In a step for acquiring the integrated feature vector by merging the object feature vector and the goal feature vector, the object feature vector is a vector representation including linguistic and semantic information about the objects present in the environment, and the goal feature vector is a vector representation reflecting a linguistic representation for the goal set by the user. The object feature vector and the goal feature vector may be merged to acquire the integrated feature vector including the association between the object and the goal. The acquisition of the integrated feature vector depends on the following Equation 2.

$${r}_{in} = ( {r}_{ing} \vert {r}_{tgt} ) \qquad ( 2 )$$

In Equation 2, rᵢₙ means the integrated feature vector, | means an operation for merging two vectors through extension of the dimension of a matrix. Here, rₜₐₜ means the given goal feature vector, and r_{ing} means the object feature vector.

This integrated feature vector is then input to a neural network encoder including an MHA layer to be used for learning a deep representation that reflects a relation between the object and goal information.

In step S220, the computing apparatus may input the integrated feature vector to the neural network encoder with MHA layers stacked therein to acquire an environmental feature vector.

The encoder available in the present disclosure may be designed in a structure in which the MHA layers are stacked, and may effectively learn interaction between the objects in the environment and a relation between the objects and the goal based on the input integrated feature vector. The encoder may serve to extract meaningful patterns and features from the input data, and in particular, the encoder of the present disclosure may have features for utilizing an MHA scheme to reinforce a relationship between the objects.

First, the encoder receives the integrated feature vector acquired by combining the goal information and the object information. The integrated feature vector may include the association between the goal and the attribute of each object present in the environment.

The encoder of the present disclosure may have a transformer-based structure and essentially include the MHA layers. The MHA layers enable learning of the same input vector in different viewpoints through various independent attention heads, which make the model identify more precisely the relation between the objects.

An MHA operation performed in the encoder is expressed as the following Equation 3.

$$E = {MHA}_{enc} ( {r}_{in} , {r}_{in} , {r}_{in} ) \qquad ( 3 )$$

In Equation 3, MHA_{enc} means the neural network encoder in which several MHA layers are stacked, and E is an output of the encoder and indicates an environmental feature vector containing a command for a given environment and comprehensive information about the objects.

In step S230, the computing apparatus may input the environmental feature vector, which is the output of the encoder, to a decoder including an MHA layer and a GRU neural network and acquire an operation feature vector.

The MHA layer is a neural network structure for learning various relations of the input data, and serves to learn how important is a specific portion of the input data in relation to the other portion. A typical attention mechanism uses three matrices including queries, keys, and values to measure similarity between the input data, and grants a higher weight to important information according to the similarity. This allows the model to determine whether specific information in the entire input data is important, and acquire an output obtained considering a correlation between specific elements.

The MHA layer operates in a manner in which multiple single-head attention mechanisms are performed in parallel, and each attention head learns different portions to enable more various information representations. The attention heads respectively independently process the input data and learn different features. Finally, outputs of all the attention heads are combined to acquire a final context vector. An MHA layer output acquired in this way may reflect various patterns of the input data and be utilized in the next steps of the neural network.

The GRU neural network has a neural network structure specialized to process time-series data or sequential data flows, and serves to maintain information of a previous time even at a current time to learn continuous data patterns. A basic GRU has a similar structure to a long short-term memory (LSTM), but utilizes an update gate, which is obtained by combining an input gate and a forget gate, and a reset gate to operate more efficiently. The update gate serves to determine, at the current time, a degree of reflecting the information of the previous time, and the reset gate serves to determine a degree of forgetting a previous state.

The essential feature of the GRU neural network is to effectively maintain state information of the previous time and remove unnecessary information to help the model be able to perform better learning. This allows the GRU neural network to learn long-term dependency.

In the present disclosure, a structure having the MHA layer and the GRU neural network utilized together to calculate an optimal task plan is implemented. First, the MHA layer analyzes various environmental elements from the input data, and learns an important relation to acquire an environmental feature vector. This environmental feature vector is input to the GRU neural network, and the GRU neural network comprehensively considers an external memory of a previous time and the environmental feature vector of the current time to acquire an operation feature vector. The operation feature vector acquired in this way is converted to elements such as an action, an object, a relation, and the like to be utilized for generating a task plan of the robot.

Consequentially, a combination of the MHA layer and the GRU neural network is designed to be able to reflect continuous changes generated within an environment in addition to simply analyzing individual elements. The MHA layer analyzes relations between various environmental elements, and the GRU neural network derives an optimal task plan while maintaining a time-series flow, thereby enabling more detailed decision making.

An MHA calculation and an operation of the GRU neural network performed in the decoder are represented as the following Equation 4.

$${h}_{t} = {MHA}_{dec} ( {E}_{t} , {M}_{t - 1} , {M}_{t - 1} ) \qquad ( 4 )$$

$${m}_{t} = GRU ( {E}_{t} , {h}_{t} )$$

The equation represents a calculation performed by the decoder at the current time t. First, the environmental feature vector Eₜ of the current time and task information Mₜ₋₁ of the previous time stored in the external memory are input to the MHA layer MHA_{dec}, and the operation feature vector hₜ of the current time is output. Here, the operation feature vector hₜ is a vector acquired in the decoder, and includes information related to an operation to be performed at the current time. This vector may be used by the robot for analyzing the environment and predicting the most suitable operation in order to achieve the given goal, and may include elements such as the action, the object, the relation, and the like.

In addition, the decoder makes it possible to utilize the information of the previous time stored in the external memory and more precisely determine an operation of the current time. Here, the external memory holds task information until the previous time, and includes a context feature vector and the environmental feature vector of the previous time. The context feature vector serves to conserve essential features related to a task plan until the previous time, and operates as an important element for maintaining the continuity of a series of operations performed by the robot. For example, when the robot performs a cooking task, it is necessary to store and utilize context information so that the robot performs “task for cutting materials” and then naturally performs “task for mixing cut materials” in succession.

Thereafter, an output operation feature vector hₜ is input to the GRU neural network to be additionally processed. The GRU neural network acquires a new state vector mₜ based on the environmental feature vector Eₜ and the operation feature vector hₜ of the current time, and the new state vector is updated in the external memory as information for task planning at a future time. This enables the decoder to maintain continuous information so as not to simply generate individual tasks but to have a consistent operation flow at each time and enable effective long-term task planning.

In step S240, based on the operation feature vector that is an output of the decoder, a sequence of one or more operations including three elements, which includes the action actually operated by the robot, the object, and the relation, may be calculated. This enables the robot to determine an optimal task flow for achieving the goal in the given environment, and concretely define a task to be performed for each step based on a time-series operation plan.

In this process, the neural network model serves to analyze the operation feature vector and derive, based on the same, the action to be performed by the robot, the object to which the action is to be applied, and the relation on which the action is performed. To this end, the neural network structure, which independently predicts each element, is used to enable the operation sequence to be more precisely generated.

First, an action output neural network predicts major operations to be performed by the robot, and the major operations may include various operations, for example, “picking”, “placing”, “cutting”, “mixing”, “grilling”, or the like. A series of operations required by the robot to perform a specific goal are sequentially determined, and each operation is configured to reflect a result in a previous step to select an optimal action.

Next, an object output neural network serves to predict a target object to which an operation required to be currently performed is applied. For example, in the case of the robot performing cooking, objects such as “onion”, “cutting board”, “bowl”, “pan”, and the like may be included, and the neural network selects an optimal object so as to properly operate the object in the given environment.

In addition, a relation output neural network may predict a relation between the objects on which the operation is performed, and the relation may include relational information such as “in”, “on”, “besides”, “under”, and the like. This serves to concretely define how a specific operation is applied when the robot performs the operation, and an optimal operation sequence may be formed when the action, the object, and the relation are to be configured together, such as “placing knife on cutting board”.

Such an operation sequence calculation process is a step for enabling the robot to efficiently perform a task in an actual environment, and more precise task planning is enabled by predicting each element through independent neural networks. This enables the robot to be designed so as to effectively perform the given goal and flexibly respond according to environmental changes.

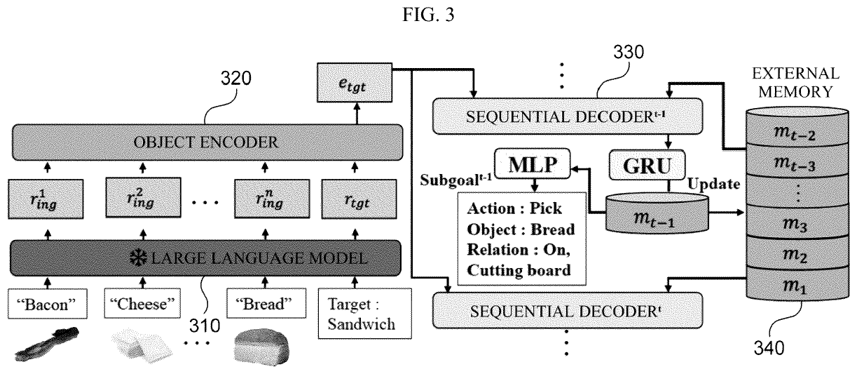

FIG. 3 illustrates a task planning framework for a task planning neural network according to an embodiment of the present disclosure.

In reference numeral 310, the computing apparatus may refine the acquired input information.

A system for planning a long-term task of the robot performs a task by receiving an input including a goal set by the user and a list of objects present in an environment. For example, when the goal is “making sandwich” and the objects in the environment are “bacon”, “cheese”, and “bread”, an LLM 310 analyzes such information to extract linguistic features.

In this process, the LLM acquires the goal feature vector r_{tgt} and the object feature vector r_{ing} based on the goal information W_{tgt} and the object list W_{ing}. The goal feature vector is a value obtained by semantically encoding a linguistic representation of the task goal set by the user, and the object feature vector is a vector reflecting attributes and relations between the objects in the environment.

Such feature vectors are then comprehensively processed by an object encoder 320 to be used for planning the long-term task.

In reference numeral 320, the goal feature vector and the object feature vector extracted through the LLM are input to the object encoder 320. The object encoder serves to learn individual properties of each object, and analyze a relation between the object and the target to identify the entire context.

To this end, the MHA layer is utilized to learn semantic relations between the objects, and through this process, the object feature vector and the goal feature vector are merged to one integrated feature vector.

The integrated feature vector is input to the encoder, the encoder acquires the environmental feature vector E that reflects the semantic relation between the object and the target, and the environmental feature vector is input to the decoder to be utilized for planning a task in subsequent steps.

In reference numeral 330, the environmental feature vector E acquired from the object encoder is transferred to the sequential decoder 330, and based thereon, the decoder generates a series of operation subgoals. The decoder has a structure in which the MHA layer and the GRU neural network are combined, and determines an optimal task by reflecting environmental information and previous task information at each time.

In an operation process of the decoder, the decoder at a current time t receives external memory information Mₜ₋₁ of a previous time and the environmental feature vector Eₜ of the current time through the MHA layer MHA_{det} to acquire an operation feature vector hₜ of the current time.

The acquired operation feature vector hₜ is input to the GRU neural network to update an external memory state mₜ of the current time, which makes it possible to continuously reflect the long-term task plan.

The operation feature vector hₜ acquired in this way is used to derive a final task plan via one or more independent neural networks. In this process, the action to be performed by the robot, the objects, and the relation between the objects are determined.

In reference numeral 340, the decoder utilizes the external memory in a task planning process to maintain a long-term task flow. The external memory stores the task information generated at the previous time, and the stored task information is used for planning current and future tasks.

When generating a new task, the decoder maintains a consistent task plan with reference to the previous task information. At each time, a new memory state mₜ is updated based on the operation feature vector hₜ acquired by the decoder, which enables the continuity of the entire task performed by the robot to be maintained.

Namely, the new memory state mₜ is added to the previous state Mₜ₋₁, which may be referenced to subsequent task planning. The external memory may be largely utilized in two manners.

A memory for storing reference information for generating a next task may hold a result of the task performed at the previous time to enable the robot to perform a continuous task. For example, when a “placing bread on cutting board” task is performed, a support is given to plan a subsequent task such as “putting cheese on bread” in a subsequent step.

A fixed external memory for storing goal information stores the goal information of the user as a feature vector form, and the goal information is stored in a manner in which the goal information is not removed but added even when the goal is changed. This allows the model to continuously learn and improve various task goals.

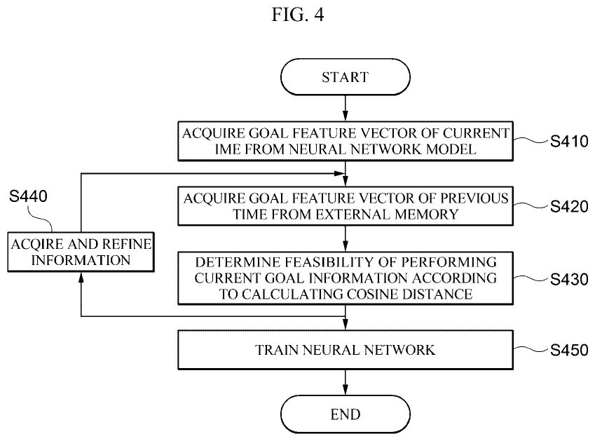

FIG. 4 is a flowchart according to a method for acquiring and refining the target information and retraining the neural network model according to an embodiment of the present disclosure when information required for generating a long-term task plan of a robot is not sufficient, and describes a process in which the neural network model is trained and refined based on the goal information to acquire the target information. The target information may mean information required for planning a long-term task for a goal of a current time. This process includes several steps from acquisition of a goal feature vector to optimization of the neural network model, and each step serves to support the robot to plan and execute the long-term task.

First, in step S410, the goal feature vector of the current time is acquired using the neural network model. The goal feature vector is a vector representation including essential information about a given task goal, and is extracted through an LLM or a trained neural network model. For example, in the case of a robot performing a specific cooking task, when a goal of “making brownie” is given, the neural network model may convert the goal into a feature vector including linguistic and object-oriented properties. This vector is a basis of a task plan to be performed in subsequent steps.

Next, in step S420, the goal feature vector of the previous time is acquired from the external memory. The external memory stores a feature vector related to a task performed at the previous time and enables the neural network model to plan a new task by referring to past information. This allows the robot to perform the task while not simply considering the current goal, but maintaining association with tasks performed in the past. For example, when “a task of mixing dough” was previously performed, “a task of placing in oven” may be naturally continued in the subsequent step.

In step S430, a cosine distance between the goal feature vector of the current time and the goal feature vector of the previous time is calculated to determine the feasibility of performing the target task. The cosine distance is a means for measuring similarity between two vectors. As a value of the cosine distance is closer to 1, the similarity is higher, and is closer to 0, a correlation is low. This makes it possible to determine whether the neural network model is suitable to perform the current goal. If a current goal feature vector is very similar to a previous goal feature vector, a current task is highly possible to overlap a task performed already. On the contrary, if the similarity is low, it may be necessary to acquire new information.

In step S440, when a cosine distance calculation value is not greater than a certain value, an information acquisition and refinement process is performed. The cosine distance functions as an indicator of a certainty level as to whether the robot has sufficient knowledge regarding a next action. Accordingly, when the cosine distance calculation value is not greater than a certain value, indicating that the certainty level is insufficient, the robot determines that additional information is needed and initiates a process of consulting external knowledge. In this step, a cosine distance analysis result may be used to compensate for insufficient information or filter unnecessary information. For example, an LLM or an external database may be used to collect additional goal information, which may be reflected to a current task plan. In addition, when wrong data or an obscure representation is included, the wrong data or obscure representation may be removed to form a more accurate feature vector. This prevents the robot from performing an unnecessary task, and helps the robot be able to plan an optimized task.

Finally, in step S450, a process for training the neural network model is performed. The neural network model is retrained based on the previously refined data, which makes it possible to acquire a more precise goal feature vector. This process enables the model to be continuously optimized, and a more accurate task to be planned every time a new target is given. In addition, when a new target is given thereafter, the trained model may be utilized for generating an immediate task plan.

Such a series of processes may support the robot to necessarily serve to plan a complex and long-term task, and the neural network to effectively utilize goal information to generate an optimal operation. This enables the robot to learn a previous task performing pattern, adapt to a new goal, and plan an optimal task.

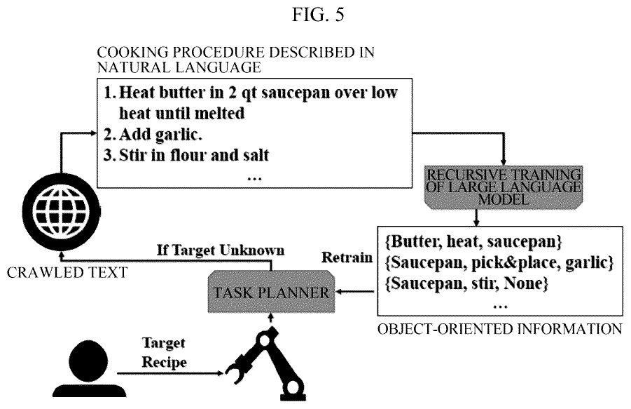

FIG. 5 is a drawing pertaining to an operation for acquiring and refining target information and retraining the neural network model according to an embodiment of the present disclosure when information required for calculating the long-term task plan of the robot is not sufficient.

This process is formed in a manner in which the robot converts a cooking procedure described in a natural language into executable object-oriented information, and is operated by an LLM in cooperation with a task planner.

First, web-crawled text is formed of sentences in a natural language such as cooking recipes. For example, cooking processes such as “heat butter in 2 qt saucepan over low heat until melted”, “add garlic”, “stir in flour and salt” are included. However, since it is difficult for the robot to directly understand and execute such natural language-based recipes, a process for converting the recipes into structured object-oriented information is necessary.

In such a conversion process, the LLM analyzes natural language data collected from a web, and understand the meanings of the sentences to extract necessary information. In this process, the LLM analyzes not just text information, but the sentences so as to be able to convert the same into specific cooking actions, objects to be operated, relations, and the like. However, since the LLM has not learned all the recipes in advance, it may be difficult for the model to perform accurate conversion on some recipes.

Here, the task planner serves to provide the robot with information about a specific target recipe. If the task planner does not know a given target recipe, the LLM may be retrained or additional information may be requested. This enables the model to recognize a new target and plan a more precise task.

Thereafter, the LLM performs recursive learning based on input natural language data, and converts the input natural language data into a structured object-oriented representation. The converted representation is stored in a form of “{butter, heat, saucepan}”, “{saucepan, pick & place, garlic)}, or “{saucepan, stir, none}”, which is converted into a command that the robot may understand. Such a conversion process makes the robot possible not to simply execute a command, but to sequentially execute several detailed tasks in order to achieve the given goal.

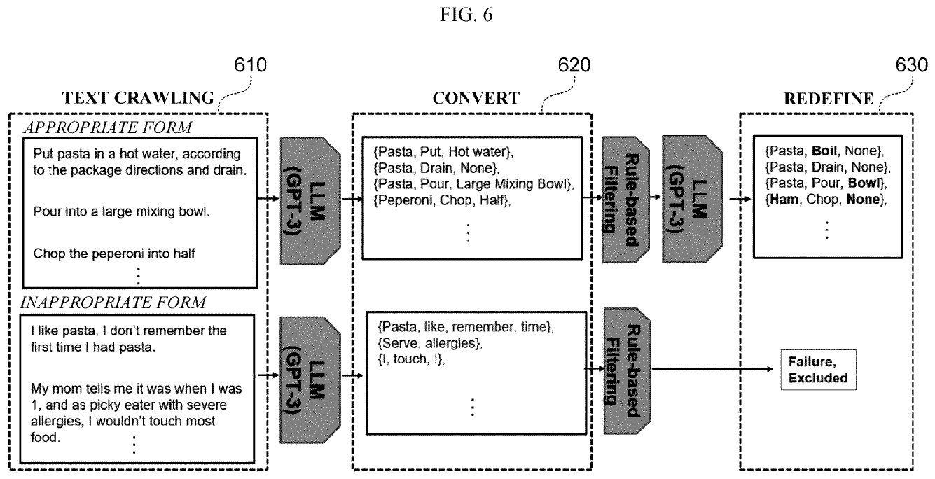

FIG. 6 is a drawing pertaining to refining collected target information according to an embodiment of the present disclosure when it is determined that information for calculating a long-term task plan is not sufficient.

The present disclosure provides a method for collecting text data in a natural language form to convert the collected text data into task-oriented actions on which the robot may actually perform. To this end, the entire process is largely configured of three steps of text crawling 610, object-oriented conversion 620, and redefining 630.

In the first step of the text crawling 610, natural language data conforming to an objective is crawled from various sources to be collected as an input. For example, a sentence like “Put pasta in hot water, according to the package directions and drain.” may be extracted from a website related to a cooking recipe. Such a sentence clearly describes a cooking process and accordingly, is considered as useful information.

In the second step of the object-oriented conversion 620, natural language text crawled using the LLM are converted into task-oriented representations. To this end, the LLM analyzes the input sentence, and then extracts essential action, object, and relation elements from the sentence to convert into structured data.

For example, like “Put pasta in hot water.”→{“Pasta, Put, Hot Water”}, “Pour into a large mixing bowl.”→{“Pasta, Pour, Large Mixing Bowl”}, “Chop the pepperoni into half.” →{“Pepperoni, Chop, Half”}, the sentences described in the natural language are converted together into a tuple structure in a form of ‘object-action-relation’. In the conversion process, rule-based filtering is applied, and when there is not a part-of-speech appropriate to each element (action, object, relation), the natural language data is considered as data irrelevant to the task and excluded. For example, a sentence like “I like pasta.” does not include a specific cooking action, and accordingly is excluded.

In addition, the converted action allows a form represented in an original sentence to be maintained without a change, and prevents unnecessary distortion of meaning.

In the third step of redefining 630, the converted data is redefined in a form that the robot may actually perform. It may be difficult for the robot to understand the representation in the natural language form, and thus a replacement process is necessary in comparison with a pre-defined action list.

For example, an action “put” may be a representation that the robot does not understand, and accordingly, “put” may be converted into “move” that is a more accurate action.

For example, conversion like {“Put”, “Pasta”, “Hot Water”}→{“Move”, “Pasta”, “Hot Water”}, {“Chop”, “Ham”, “None”}→{“Cut”, “Ham”, “None”} may be performed to refine a task sequence that the robot may execute.

Through such a series of steps, the present disclosure may automatically analyze text data provided in a form of a natural language, and covert the text data into structured task data executable by the robot. Finally refined data may be utilized as training data of the robot or directly used in an actual task planning process.

When using the method of the present disclosure, a natural language-based cooking method may be automatically converted into an execution command of the robot, and various automation systems including a cooking robot may analyze and execute the natural language command more effectively.

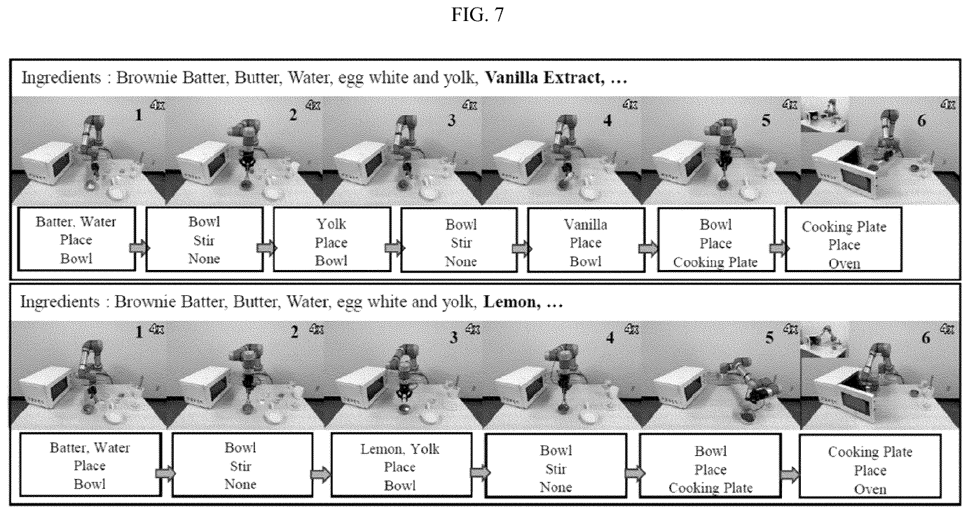

FIG. 7 illustrates an example that the computing apparatus of the present disclosure executes the task planned for the robot to achieve a goal for making brownie.

The drawing visually represents an example in which the robot automatically performs a process for making brownie. The robot performs the task step by step according to the given goal, and performs a cooking process in a manner in which a specific operation is executed in each step. An upper sequence and a lower sequence show two cases in which the same task is performed using different materials.

First, necessary materials are presented at the start of each sequence. Materials such as brownie batter, butter, water, egg white and yolk, vanilla extract, and the like are used in the upper sequence, and materials such as brownie batter, butter, water, egg white and yolk, lemon, and the like are used in the lower sequence. In this way, the same basic materials are included, but a specific material (vanilla extract or lemon) shows a difference that may be considered as reflecting variants of a recipe.

In the first step, the robot performs a task of bringing and putting brownie batter and water in a bowl. This is an initial process for mixing the materials, which means that the batter and a liquid component are collected in one container. In the second step, a process for the robot to grasp the prepared container, and stir and mix the inner contents is performed. This is an important step for causing the batter and the liquid to be uniformly mixed.

In the third step, a process for placing additional materials according to the recipe is performed. The egg yolk is brought and placed in the container in the upper sequence whereas the lemon and the egg yolk are placed together in the lower sequence. In this way, there is a difference in specific materials even in the same recipe, which shows that the automated robot may flexibly perform various variants of the recipe.

In the fourth step, additional flavor ingredients such as vanilla extract and lemon may be included, and in the fifth step, the robot performs a task of grasping the prepared container and placing the container on a cooking plate. This process is a step for preparing to heat and cook batter, which corresponds to essentials of cooking.

In the final sixth step, a process for placing the cooked batter in oven is performed. This is a final baking step, which means that the robot completes all pre-tasks and finishes the cooking process. This completes an automated cooking process, and shows that the robot for itself may understand the recipe and perform an optimal task according to a combination of materials and an order.

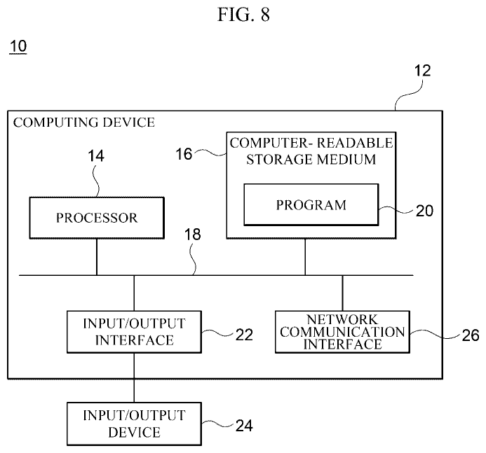

FIG. 8 is a block diagram showing a configuration of a computing apparatus according to an embodiment of the present disclosure.

The illustrated computing environment 10 includes a computing apparatus 12. In an embodiment, the computing apparatus 12 may perform a method for planning a long-term task of a robot described in FIGS. 1 to 7.

The computing apparatus 12 includes at least one processor 14, a computer-readable storage medium 16, and a communication bus 18. The processor 14 may cause the computing apparatus 12 to operate according to the aforementioned illustrative embodiments. For example, the processor 14 may execute one or more programs stored in the computer-readable storage medium 16. The one or more programs may include one or more computer-executable instructions, and when executed by the processor 14, the computer-executable instructions may cause the computing apparatus 12 to perform operations according to the illustrative embodiments.

The computer-readable storage medium 16 is configured to store the computer-executable instructions or program codes, program data and/or other suitable types of information. The programs 20 stored in the computer-readable storage medium 16 include a set of instructions executable by the processor 14. In one embodiment, the computer-readable storage medium 16 includes a memory (a volatile memory such as a random access memory, a nonvolatile memory, or a suitable combination thereof), one or more magnetic disk storage devices, optical disk storage devices, flash memory devices, or any other types of storage media that are accessible by the computing apparatus 12 and capable of storing desired information, or a suitable combination thereof.

The communication bus 18 interconnects various other components of the computing apparatus 12 including the processor 14 and the computer-readable storage medium 16.

The computing apparatus 12 may also include at least one input/output interface 22 for at least one input/output apparatus 24 and at least one network communication interface 26. The input/output interface 22 and the network communication interface 26 are connected to the communication bus 18. The input/output apparatus 24 may be connected to other components of the computing apparatus 12 through the input/output interface 22. The illustrative input/output apparatus 24 may include a pointing apparatus (a mouse or a track pad. or the like), a keyboard, a touch input apparatus (a touch pad, a touch screen, or the like), an input apparatus such as a voice or sound input apparatus, various types of sensor apparatuses, and/or an imaging apparatus, and/or an output apparatus such as a display apparatus, a printer, a speaker, and/or a network card. The illustrative input/output apparatus 24 which is one component constituting the computing apparatus 12 may be included inside the computing apparatus 12, and may be connected to the computing apparatus 12 as a separate apparatus from the computing apparatus 12.

The system for planning a long-term task of a robot described through FIGS. 1 to 8 may be implemented as a computer program stored in a computer-readable recording medium executed by a computer, or in a form of a recording medium including instructions executable by a computer. In addition, the method for planning a long-term task of a robot described through FIGS. 1 to 8 may be embodied as a computer program that is stored in a computer-readable recording medium and executed by a computer.

The computer-readable recording medium may be an arbitrary available medium accessible by a computer, and includes all volatile/non-volatile media and removable/non-removable media. In addition, the computer-readable recording medium may include a computer storage medium. The computer storage medium includes all volatile/non-volatile media and removable/non-removable media embodiment by a certain method or technology for storing information such as computer-readable instructions, a data structure, a program module or other data.

Program instructions may include high-level language code executable by a computer using an interpreter in addition to machine code created by a complier. The hardware apparatus may be configured to operate as at least one software module to perform an operation of various embodiments and vice versa.

The foregoing description of the present disclosure has been presented for the purposes of illustration and description. It is apparent to a person having ordinary skill in the art to which the present disclosure relates that the present disclosure may be easily modified into other detailed forms without changing the technical principle or essential features of the present disclosure. It is therefore to be understood that the above-described embodiments are illustrative in all aspects and not restrictive. For example, each component described to be of a single type may be implemented in a distributed manner. Likewise, components described to be distributed may be implemented in a combined manner.

Although the representative embodiments of the present disclosure have been described in detail above, those skilled in the art will appreciate that various modifications may be made to the above-described embodiments without departing from the scope of the present disclosure. Therefore, the scope of the present disclosure should not be limited to the described embodiments, but should be defined by the claims below and equivalents thereof.

According to the disclosed embodiments, a given environment may be understood with a natural language based on a language model, and the properties may be extracted from the natural language through the language model to obtain general knowledge for the environment.

According to the disclosed embodiments, optimal task planning may be performed at each time with reference to context information and environmental information about a previous task in an external memory, and environmental information and context information after a task may be stored in the memory.

According to the disclosed embodiments, when knowledge is not sufficient, a more accurate task plan may be calculated by searching online for information about a goal, and then refining the discovered information and training a neural network again.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An operation method performed in a computing apparatus comprising one or more processors and a memory for storing one or more programs executed by the one or more processors, the method comprising:
acquiring input information represented in a natural language and object-oriented information;
calculating, by a neural network model, a time-series task plan of a robot based on the input information; and
acquiring target information for achieving the time-series task plan and retraining the neural network model when the information for calculating a long-term task plan is determined not to be sufficient.

2. The operation method of claim 1, wherein the calculating of the time-series task plan comprises:
refining the input information to acquire an input feature vector;
inputting the input feature vector to an encoder to acquire an environmental feature vector including object information and a command for an environment;
inputting the environmental feature vector to a decoder to acquire an operation feature vector including information about an operation to be performed at a specific time; and
outputting one or more operation sequences corresponding to the time-series task plan based on the operation feature vector.

3. The operation method of claim 2, wherein the refining of the input information comprises converting object information and goal information included in the input information into a language model to acquire an object feature vector and a goal feature vector.

4. The operation method of claim 2, wherein the encoder is a neural network encoder in which one or more multi-head attention layers are stacked, and
wherein the calculating of the time-series task plan comprises:
merging the object feature vector and the goal feature vector through the encoder to acquire an integrated feature vector; and
inputting the integrated feature vector to the encoder to acquire, through the encoder, the environmental feature vector reflecting a comprehensive feature of the environment.

5. The operation method of claim 2, wherein the decoder comprises at least one multi-head attention layer and a gated recurrent unit neural network.

6. The operation method of claim 5, further comprising:
acquiring the environmental feature vector of a current time and task information of a previous time stored in an external memory to acquire a current operation feature vector as an output of the multi-head attention layer,
wherein the task information of the previous time comprises a context feature vector of the previous time and an environmental feature vector of the previous time.

7. The operation method of claim 5, wherein the gated recurrent unit neural network combines a current operation feature vector, which is an output of the multi-head attention layer, and a current environmental feature vector, which is an output of the encoder, to acquire a memory feature vector and update an external memory.

8. The operation method of claim 6, wherein the acquiring of the output from the operation feature vector comprises:
inputting the feature vector to at least one independent neural network; and
outputting an action, an object, and a relation from the independent neural network.

9. The operation method of claim 1, wherein the acquiring of the target information comprises:
acquiring a goal feature vector of a current time from the neural network model;
acquiring a goal feature vector of a previous time stored in an external memory;
comparing the goal feature vector of the previous time and the goal feature vector of the current time to determine feasibility of performing current goal information;
acquiring and refining information related to the goal information of the current time based on the determining of the feasibility; and
comprising the refined information to retrain the neural network model.

10. The operation method of claim 9, wherein the determining of the feasibility comprises calculating a cosine distance between the goal feature vector of the previous time and a feature vector of a new goal.

11. The operation method of claim 10, further comprising:
acquiring and refining information related to the goal information of the current time to retrain the neural network model when a result value of the calculating of the cosine distance is not greater than a certain value.

12. The operation method of claim 11, wherein the acquiring of the information comprises web-crawling related information using the goal information of the current time as a keyword.

13. The operation method of claim 12, wherein the refining of the information comprises:
extracting linguistic properties of the crawled information to measure a distance with the goal information of the current time, and removing irrelevant information when the distance is not greater than a specific numeral;
utilizing a language model to organize information with a minimum number of operations, and identifying continuity of the operations to remove information without the continuity; and
using the language model to verify whether each operation is convertible to a structure that is understandable and performable by the robot.

14. A computing apparatus comprising:
a processor; and
a memory storing one or more programs executed by the processor,
wherein the processor performs:
acquiring input information represented in a natural language and object-oriented information;
calculating, by a neural network model, a time-series task plan of a robot based on the input information; and
acquiring target information for achieving the time-series task plan and retraining the neural network model when information for calculating a long-term task plan is determined not to be sufficient.

15. The computing apparatus of claim 14, wherein the processor performs:
refining the input information to acquire an input feature vector;
inputting the input feature vector to an encoder to acquire an environmental feature vector including object information and a command for an environment;
inputting the environmental feature vector to a decoder to acquire an operation feature vector including information about an operation to be performed at a specific time; and
outputting at least one operation sequence corresponding to a time-series task plan based on the operation feature vector.

16. The computing apparatus of claim 14, wherein the processor performs:
acquiring a goal feature vector of a current time from the neural network model;
acquiring a goal feature vector of a previous time stored in an external memory;
comparing the goal feature vector of the previous time and the goal feature vector of the current time to determine feasibility of performing current goal information;
acquiring and refining information related to the goal information of the current time based on the determining of the feasibility; and
comprising the refined information to retrain the neural network model.

17. A computer program stored in a non-transitory computer readable storage medium, the computer program comprising:
one or more instructions, wherein, when executed by a computing apparatus comprising one or more processors, the instructions cause the computing apparatus to perform:
acquiring input information represented in a natural language and object-oriented information;
calculating, by a neural network model, a time-series task plan of a robot based on the input information; and
acquiring target information for achieving the time-series task plan and retraining the neural network model when information for calculating a long-term task plan is determined not to be sufficient.
